(19) United States
(12) Patent Application Publication
(10) Pub. No.: US 2019/0269947 A1
(43) Pub. Date: Sep. 5, 2019

(54) Oxygen Transport and Flotation Device

(71) Applicants: Stephen Erickson, University Place, WA (US); Sharon Erickson, University Place, WA (US)

(72) Inventors: Stephen Erickson, University Place, WA (US); Sharon Erickson, University Place, WA (US)

(21) Appl. No.: 16/298,814

(22) Filed: Mar. 11, 2019

(51) Int. Cl. A62B 25/00; B62B 5/06; B62B 1/14; B62B 1/26; B62B 5/00

(52) U.S. Cl. CPC A62B 25/00; B62B 5/065; B62B 1/14; B62B 2203/44; B62B 5/00; B62B 2202/022; B62B 1/264

(57) ABSTRACT

This is a flotation transport device for portable oxygen tanks, created to allow anyone dependent upon supplemental oxygen to do two things: transport the device and tank with ease to the edge of the pool using wheels and a handle that extends; and secondly to provide a floating case to be used in the pool or shallow water for recreation, exercise or therapy. This device provides an accommodation for people who are dependent upon oxygen to use the pool like everyone else. The device consists of three connected pieces: the plastic carrying case; the foam board; and the expandable transport mechanism.

### CROSS REFERENCE TO RELATED APPLICATIONS

Cross reference to Oxygen Flotation Device patent #9598158B2.

### STATEMENT REGARDING FEDERALLY SPONSORED RESEARCH OR DEVELOPMENT

Not applicable to this application.

### BACKGROUND OF THE INVENTION

Medical type device designed for Transport and for aquatic purposes relating to small portable oxygen tanks used by people who are dependent upon supplemental oxygen.

### BRIEF SUMMARY

This device allows people who are dependent upon supplemental oxygen to both transport on land and float their portable oxygen tank in the pool. It allows a person to secure the portable oxygen tank in the device and then wheel it to the edge of the pool; and then to easily get into the pool and collect the device from the pool's edge.

The device secures the tank so that there is no pull on the cannula while the person is in the pool for the purpose of water therapy, medical aqua therapy, pulmonology rehabilitation, low impact water exercise, water walking and personal water recreation.

This device has not been anticipated, rendered obvious, suggested, or even implied by any other individual or company.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### What it is not

It is not meant to be used like a kickboard and it is not a toy. It is not intended for swimming or a life saving device. It is not for use in large bodies of water, or water deeper than your chest. The Transporter mechanism is only meant to be used in conjunction with this device and is not to be used as a toy.

### BRIEF DESCRIPTION OF THE DRAWINGS

FIG. 1 on Sheet 1 of 26 is a complete perspective of the device from the top of Prototype A.

FIG. 2 on Sheet 2 of 26 is a top perspective view of the present invention in use of Prototype A.

FIG. 3 on Sheet 3 of 26 is a top perspective view of the present invention in use with handle extended of Prototype A.

FIG. 4 on Sheet 4 of 26 is a top view of the present invention in use with its lid open of Prototype A.

FIG. 5 on Sheet 5 of 26 is a back perspective of the present invention of the bottom back plastic cover of Prototype A.

FIG. 6 on Sheet 6 of 26 is a perspective of the inside of the bottom plastic piece with handle attachment glued flat to the plastic piece with wheels of Prototype A.

FIG. 7 on Sheet 7 of 26 is a side perspective of the bottom plastic piece and the hinges and clasp and wheels of Prototype A.

FIG. 8 on Sheet 8 of 26 is a top perspective of the Transport mechanism and wheels when it is not expanded of Prototype A.

FIG. 9 on Sheet 9 of 26 is a top perspective of the Transport mechanism and wheels when expanded of Prototype A.

FIG. 10 on Sheet 10 of 26 shows the two parts of the Transport mechanism; top and bottom.

FIG. 11 on Sheet 11 of 26 show the wheel marked as 5 with the swivel top, marked as 5.1 that connects to the Transport mechanism bottom piece marked as 3.1.

FIG. 12 on Sheet 12 of 26 is the top view of the foam piece that includes the rectangular 2.5 inch width, 11.5 inch length angular cut for the portable oxygen tank to sit of Prototype A

FIG. 13 on Sheet 13 of 26 is the back view of the foam piece which shows the small parallel indentations in the foam and the bottom perpendicular cut marked as 7.3 which will fit over the Transport mechanism located on the top inside of the bottom plastic piece of Prototype A

FIG. 14 on Sheet 14 of 26 is a drawing of the top and bottom clasp of Prototype A.

FIG. 15 on Sheet 15 of 26 is a picture of the top and bottom hinge which will connect on the top edge of the device of Prototype A.

FIG. 16 on Sheet 16 of 26 includes drawings that provide an expanded summary of the individual pieces and how they fit together as well of Prototype A. The first drawing shows the plastic carrier with both top and bottom pieces connected by the hinge and open.

The second shows the plastic carrier in the open position with the Transport mechanism glued to the inside bottom of the plastic carrier.

The third drawing shows the foam piece which has the top view of the foam piece that includes the rectangular 2.5 inch width, 11.5 inch length angular cut for the portable oxygen tank to sit; and the back side of the foam that has the the back view of the foam piece which shows the small parallel indentations in the foam which will fit over the Transport mechanism located on the top inside of the bottom plastic piece.

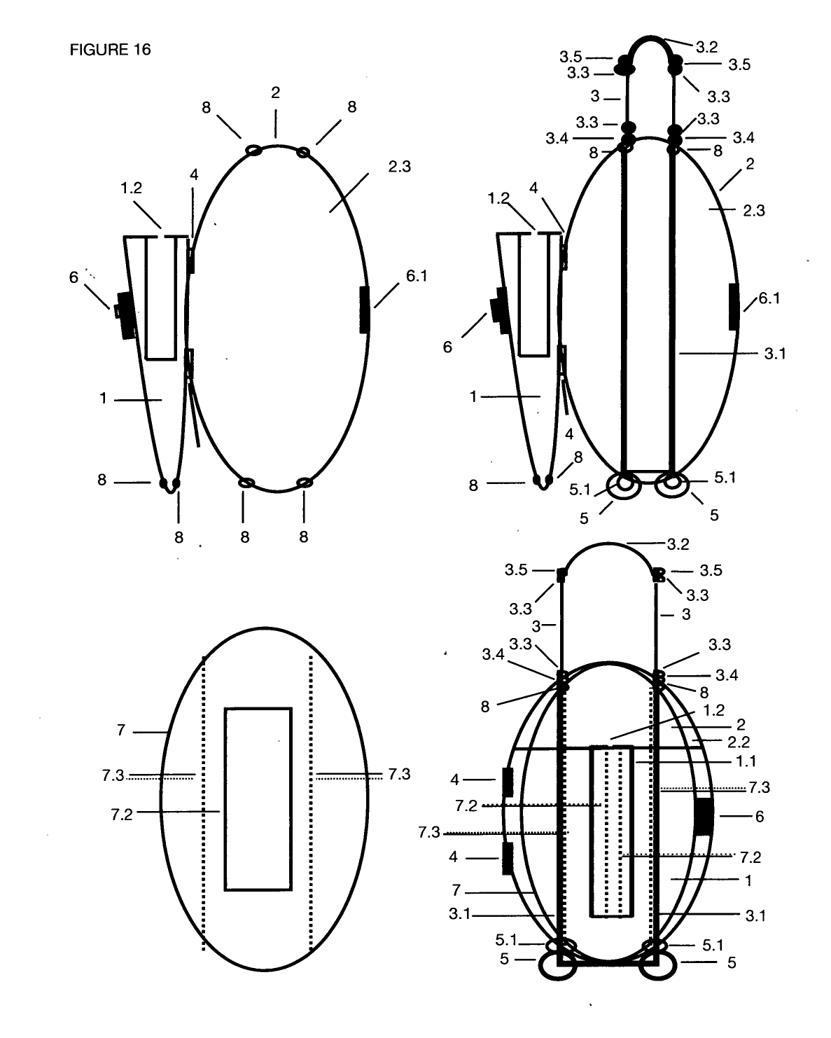

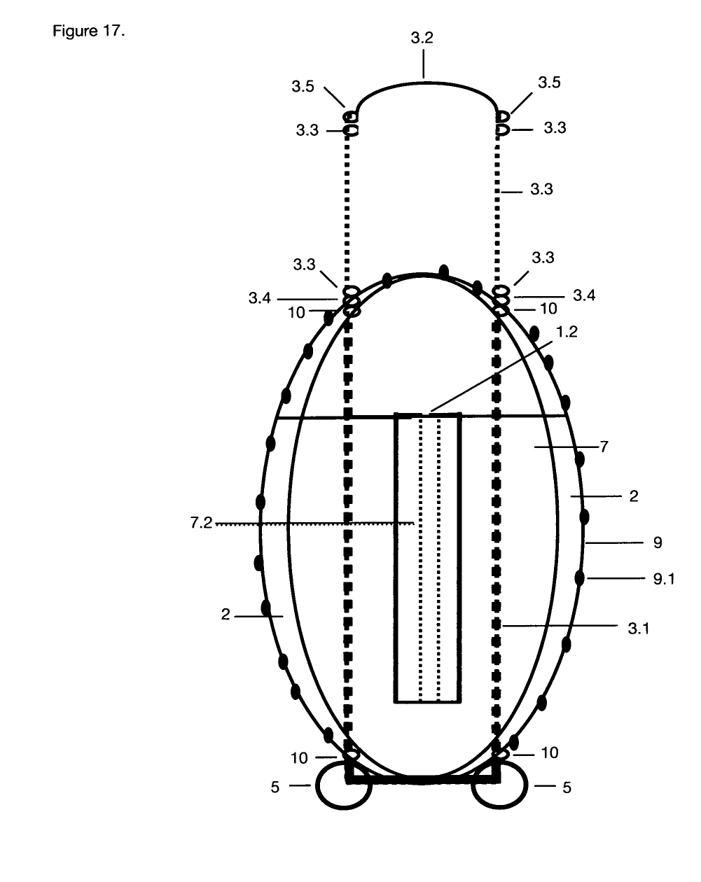

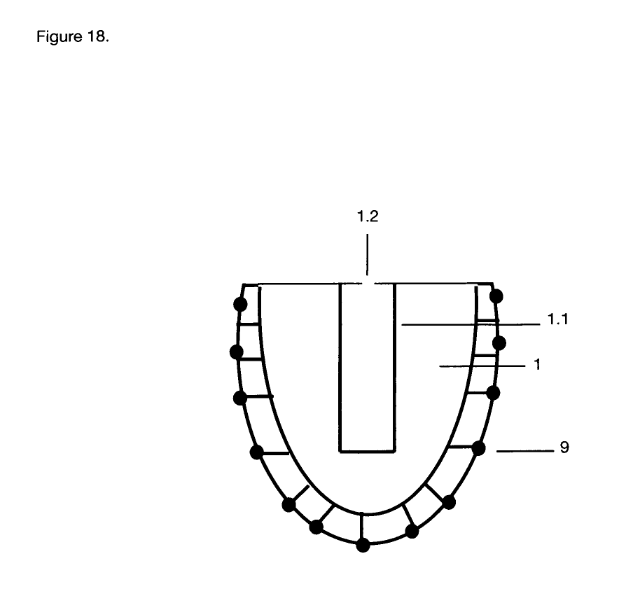

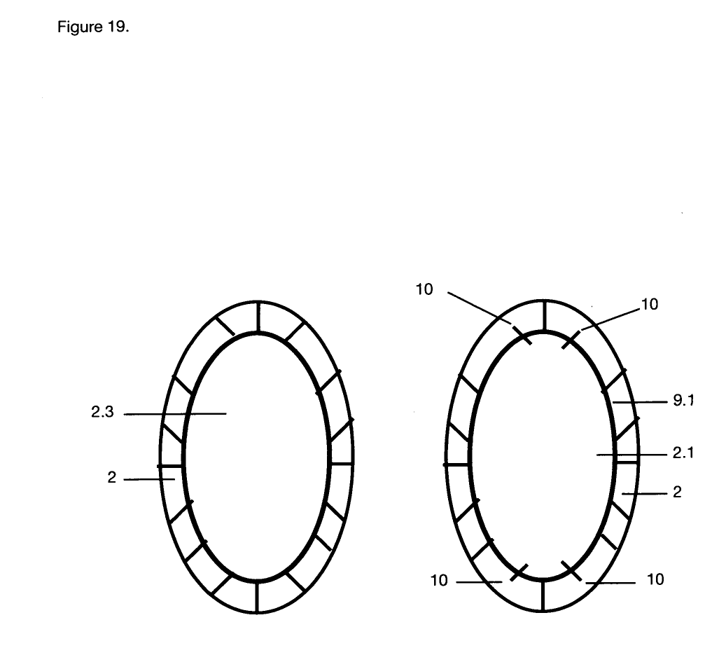

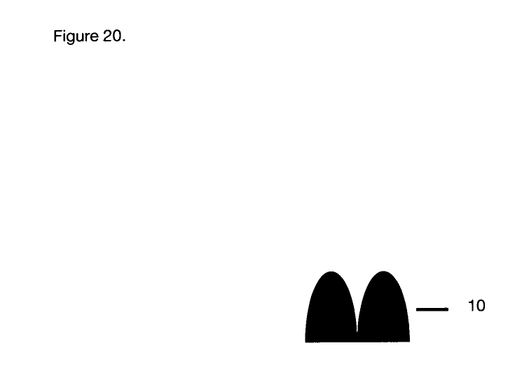

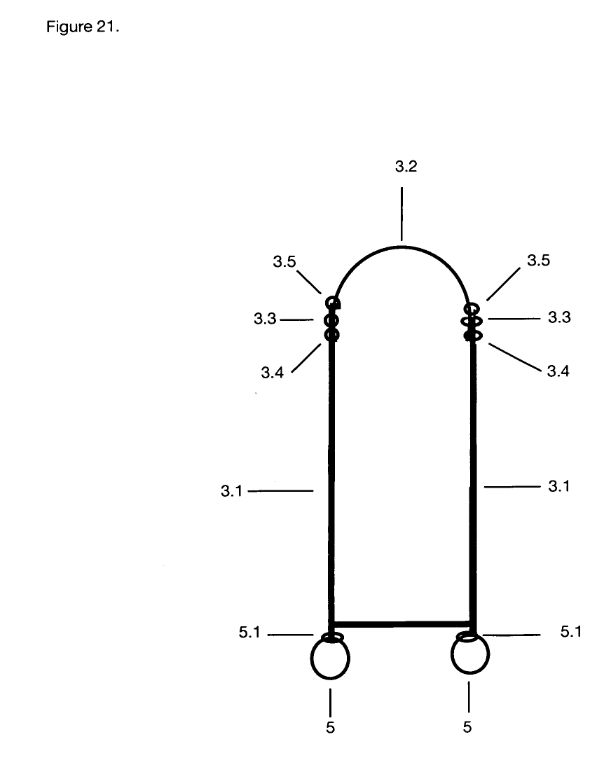

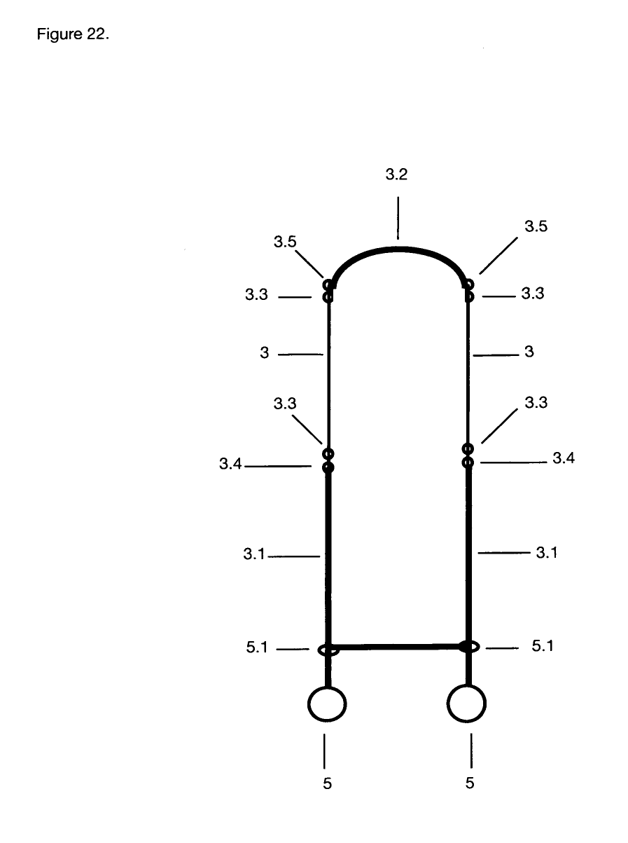

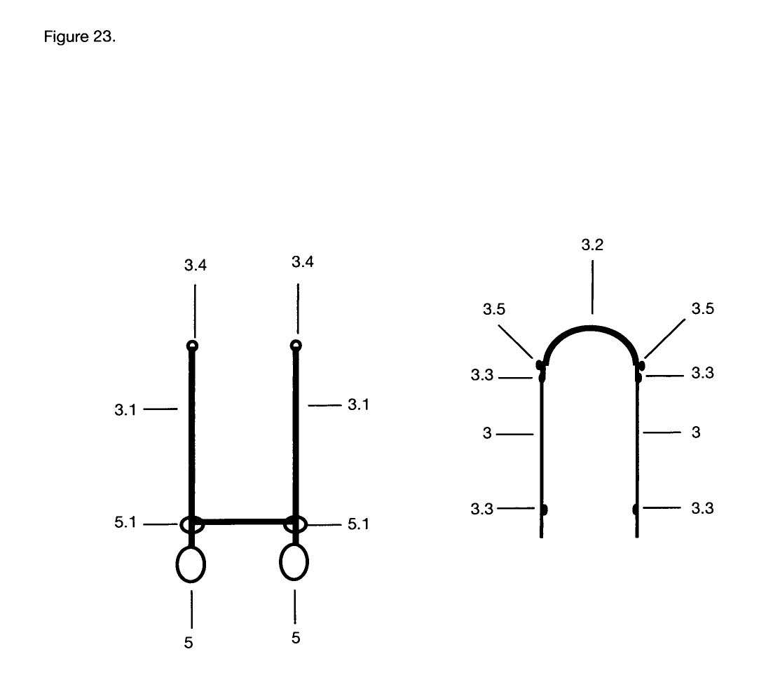

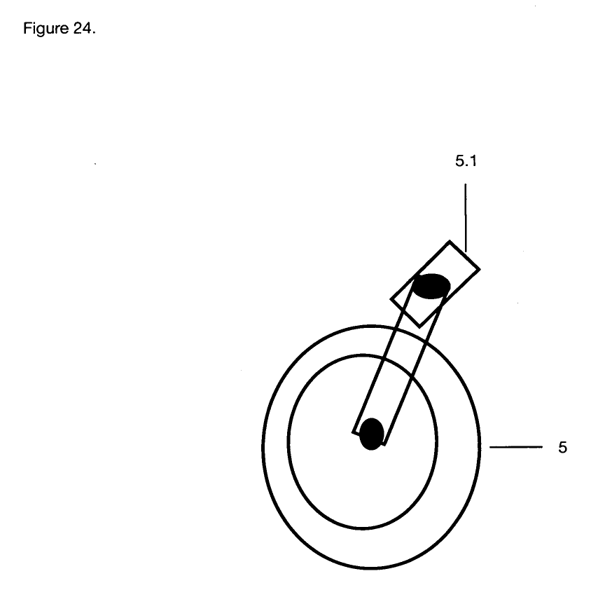

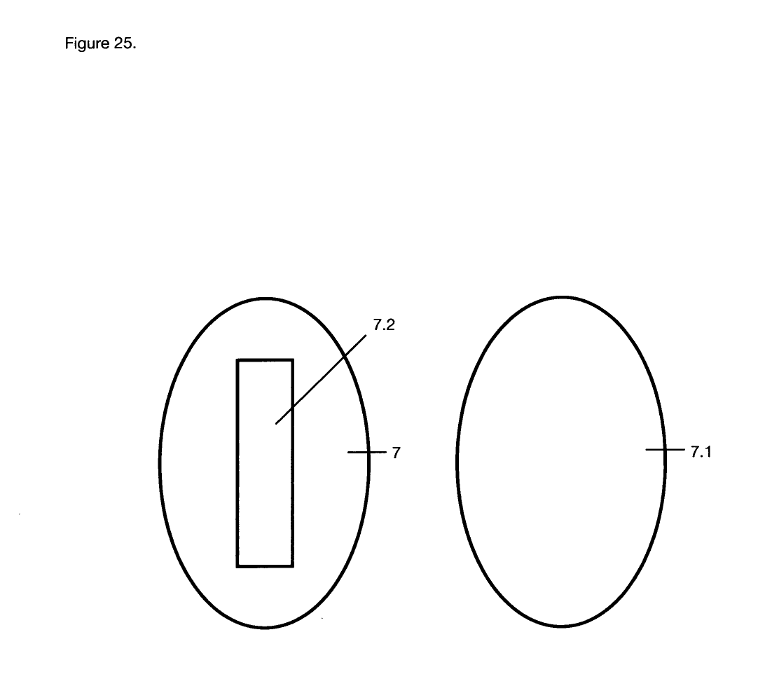

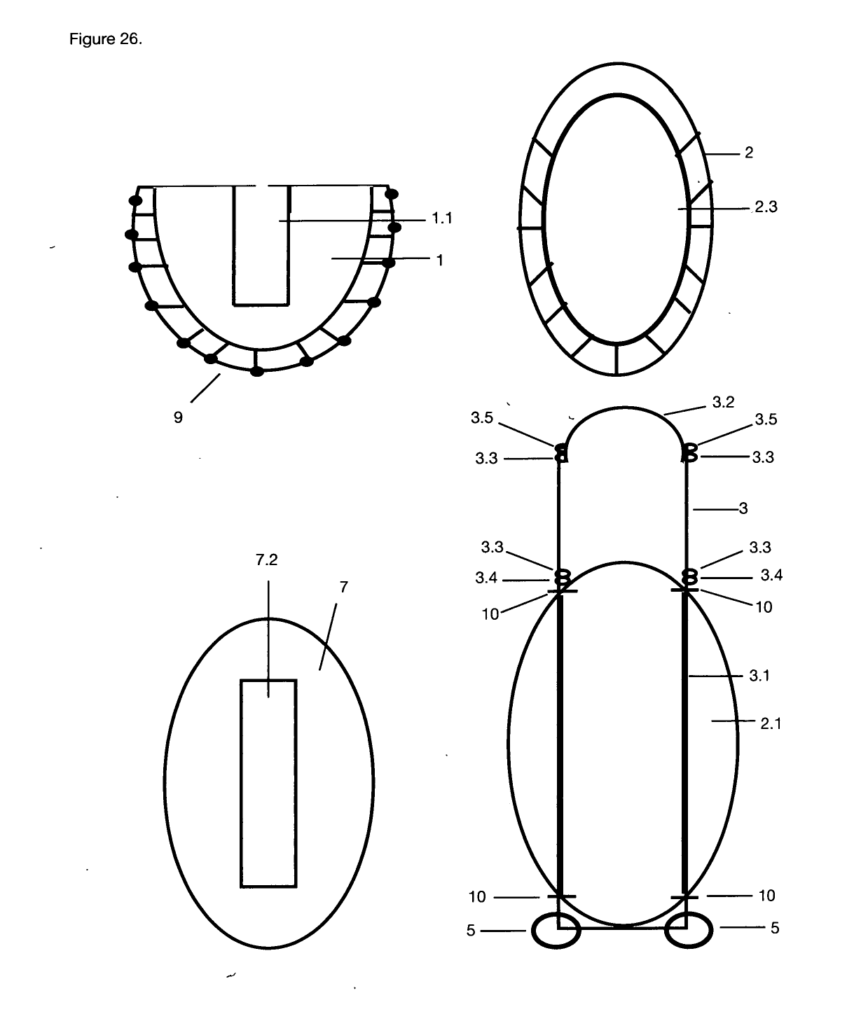

The final drawing in FIG. 16 demonstrates the whole device put together of Prototype A.

FIG. 17 on Sheet 17 of 26 is a complete drawing of Prototype B which has two pieces of plastic that are completely separate—the top lid fits over the bottom lid and seals over the bottom lids lip; the foam which fits into the bottom plastic carrier piece, has the same top cut for the portable tank as Prototype A, but has no back cut. The Transport mechanism and wheels are the same as in Prototype A but it is connected to the back bottom piece of plastic by four corner clips. This allows for easy removal of the Transport mechanism when entering the pool.

FIG. 18 on Sheet 18 of 26 shows the top piece of plastic, called the lid of the device. It has an outward angled center that is 3.2 inches in diameter and fits snuggly over the portable oxygen tank B of Prototype B.

FIG. 19 on Sheet 19 of 26 is a drawing of the bottom piece of the plastic carrier from the back piece marked as 2 to the front of the bottom piece marked as 2.1 of Prototype B.

FIG. 20 on Sheet 20 of 26 is a drawing of one of the four clips marked as 10, which are placed on the back of the plastic carrier and hold the Transport mechanism device of Prototype B.

FIG. 21 on Sheet 21 of 26 is a drawing of the Transport mechanism with wheels when it is not expanded of Prototype B.

FIG. 22 on Sheet 22 of 26 is an expanded drawing of the Transport mechanism of Prototype B.

FIG. 23 shows the two parts of the Transport mechanism; top and bottom.

FIG. 24 show the wheel marked as 5 with the swivel top that connects to the Transport mechanism bottom piece marked as 3.1.

FIG. 25 is two drawings of the top and bottom side of the foam. The top piece has the 2.5 inch by 11.5 inch length and 0.5 inch depth cut for the portable oxygen B tank to fit of Prototype B. The bottom side of the foam is flat.

FIG. 26 on Sheet 26 of 26 shows the expanded drawing as follows: the first drawing is the top lid which has the outer extended plastic in the middle and the cut hole in the top of that middle piece which fits over the top of the top end of the portable oxygen tank nipple; the second drawing is a picture of the bottom piece of the plastic carrier; the third drawing shows the foam with the top center indented cut of 2.5 in width, 11.5 length and 0.5 angled in cut into the foam; the fourth drawing shows the back of the plastic carrier with the Transport mechanism placed into the clips attached to the plastic carrier. This drawing also explains how the device is assembled for Prototype B.

### EXPLANATION

This invention serves as a Transport mechanism for a size B portable oxygen tank, and as a flotation device which securely holds the portable oxygen tank in place so that there is no pull on the user's cannula.

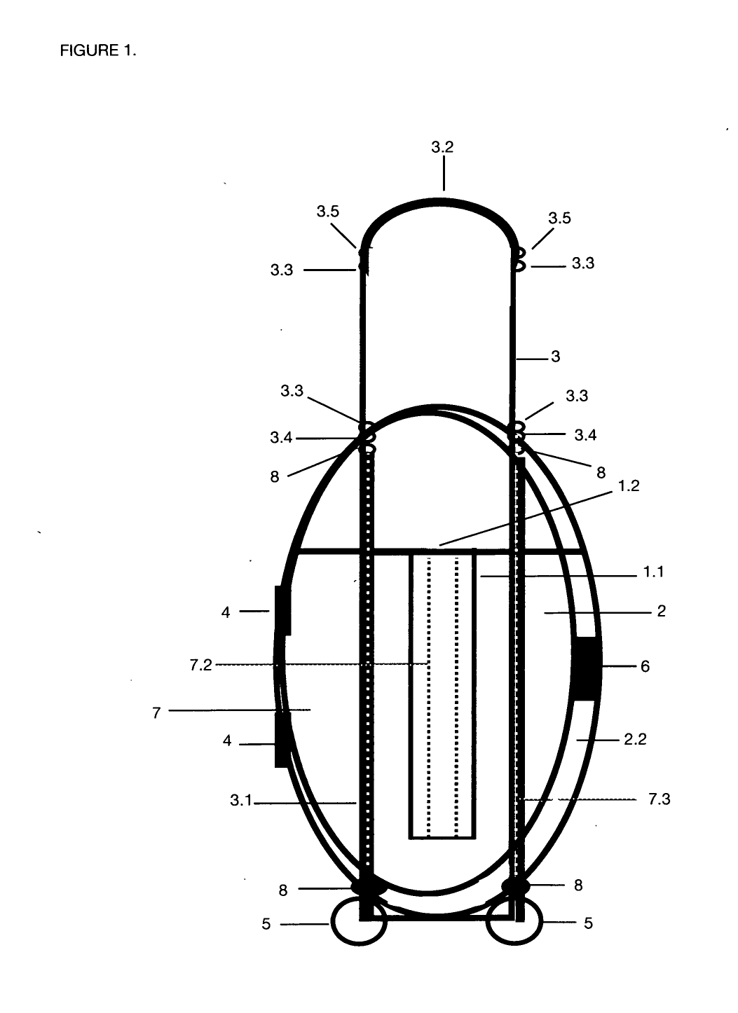

The Device for both Prototypes is oval in shape and is 17 and ⅝ths inches in length and 12 and ⅛th inches in width. Its depth ranges from 1 and ⅝ths for all of the board with exception to the curved element described as 1.1 in FIGS. 1, 2, 3, 4, 16 for Prototype A and FIGS. 17, 18, 26 for Prototype B where it is 4.235 inches.

The device includes 3 main pieces: the plastic case which is ⅛ths of an inch thick over both top and bottom plastic pieces. FIGS. 1, 2, 3, 4, 5, 6, 7, 16, for Prototype A, and 17, 18, 19, 26 for Prototype B; the closed cell foam FIGS. 1, 4, 12, 13, 16 for Prototype A and FIGS. 17, 25, 26 for Prototype B which in both Prototypes is glued to the bottom of the plastic case; and the expandable Transport mechanism seen in FIGS. 1, 3, 6, 7, 8, 9, 10, 11, 16 for Prototype A and FIGS. 17, 21, 22, 23, 24, 26 for Prototype B.

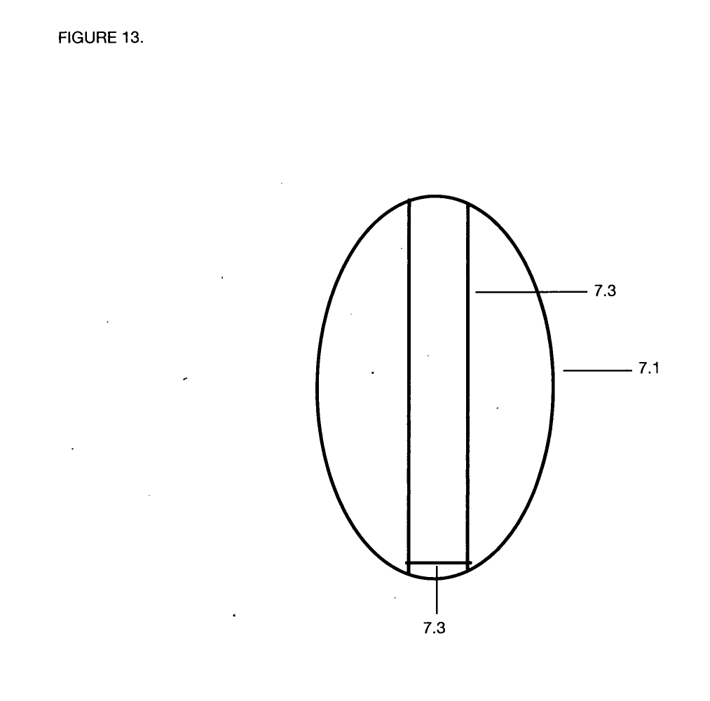

The plastic case consists of 2 pieces: The top lid for both Prototypes is marked as 1 and the bottom plastic piece is marked as 2. The top lid opens and closes with a hinge system (FIG. 13) in Prototype A as seen in FIGS. 1, 2, 3, 4, 5, 7, 15, 16, the top lid and bottom plastic carrier for Prototype A both have small circular holes marked as 8 and seen in FIGS. 1, 3, 5, 6, 7, 16, so the rods labeled 3.1 of the Transport mechanism can pass through the plastic for the wheels (5) to be attached.

The top lid in Prototype B does not have a hinge system but is placed over the bottom lid's lips (9, 9.1). The lid in both Prototypes is 13 inches in length, oval until the 13th inch mark where it becomes a straight perpendicular line across the top and is found in FIGS. 1, 2, 3, 4, 16 of Prototype A and 17, 18, 26 for Prototype B. The top lid for both Prototypes has the same upper configuration that is marked as 1.1 representing the Lid's middle aspect which has perpendicular flat edges at either ends and a curved piece on top of the device; it is 11.5 inches in length (both edges in length are flat) and 3.2 inches in width, the top of this plastic is 4.325 inches from the base and is curved at about 108 degrees and can be seen in FIGS. 1, 2, 3, 4, 16 for Prototype A and in FIGS. 17, 18, 26 for Prototype B.

1.2 which marks the element at the top end of the outward curve that is a cutting the center of 1.75 inch rectangular cut that allows the top lid to fit over the oxygen tanks nipple and can be seen in FIGS. 1, 2, 3, 4, 16 in Prototype A and FIGS. 17, 18, 26 for Prototype B. The rest of the plastic case, the bottom piece, which is one piece is marked as 2, 2.1, 2.2, 2.3, is found in FIGS. 1, 2, 3, 4, 5, 6, 7, 16 for Prototype A.

For Prototype B the bottom piece marked as 2 stops at the top edge of the board without continuing over the top of the foam and can be seen in FIGS. 17, 19, 26. This piece is similar to an oval baking dish and has a depth of 1.5 inches for the foam piece.

The foam board labeled as 7 is made from closed cell polyethylene or other, (see other possible construction materials at end of explanation) that fills the space inside the bottom plastic piece marked as 2, is glued to the bottom plastic piece and listed in FIGS. 1, 4, 12, 16. The foam board piece for both Prototypes measures, 11. 5 inches in width and is 17 inches in length in an oval shape and has an inward angular cut marked as 7.2 which demonstrates the hole in the foam where the portable oxygen tank B will be placed and is further described as follows: It is 2.5 inch wide by 11.5 inch long inverted hole/curve, of approximately 108 degree angle that is 0.5 inches deep, perpendicular at its length edges. These elements can also be found in FIGS. 1, 4, 12, 16 for Prototype A and 17, 25, 26 in Prototype B. Only the closed cell foam board for Prototype A has cuts on the back of its board marked as 7.3 which represents the two 17 inch in length and perpendicular cut completing the open rectangular configuration which are ⅛th of an inch in diameter, curved inward indentations/cuts as seen in FIGS. 1, 13, 16, that will allow the Transport mechanism to fit snugly over the rods marked 3.1 so the foam can be glued flat over the inside bottom plastic piece marked as which can be seen in FIGS. 1, 4, 12, 16.

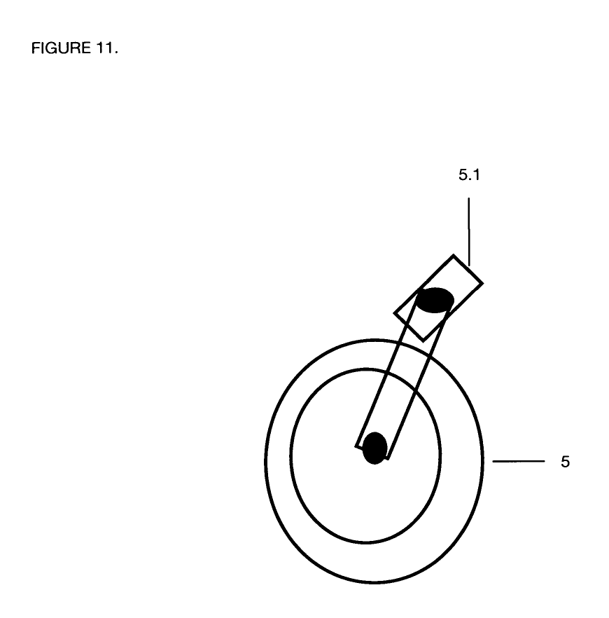

The Transport mechanism is the same for both Prototypes. It is labeled as 3, 3.1 and 5. It consists of three pieces: the lower rod, (3.1) which which is 3/16ths of an inch in diameter and has several holes and is 18 inches in length both rods running 6 inches parallel to each other; the smaller rod (3) which is 2/16ths of an inch and is 14 inches in length running 6 inches parallel to each other and has small circular retractable nobs that spring into the holes of the lower rod and the wheels (5) and the swivel piece marked as 5.1 the swivel piece is connected to 3.1 and can be seen in FIG. 11 for Prototype A and 24 for Prototype B which are attached to the lower rod known as 3.1. The Transport mechanism can be seen in FIGS. 1, 2, 3, 4, 5, 6, 7, 8, 9, 10, 16 for Prototype A and in FIGS. 17, 21, 22, 23, 24, 26 for Prototype B. In Prototype B the Transport mechanism is not inside the plastic carrier but is attached to the outside back of the the bottom plastic case 2.1.

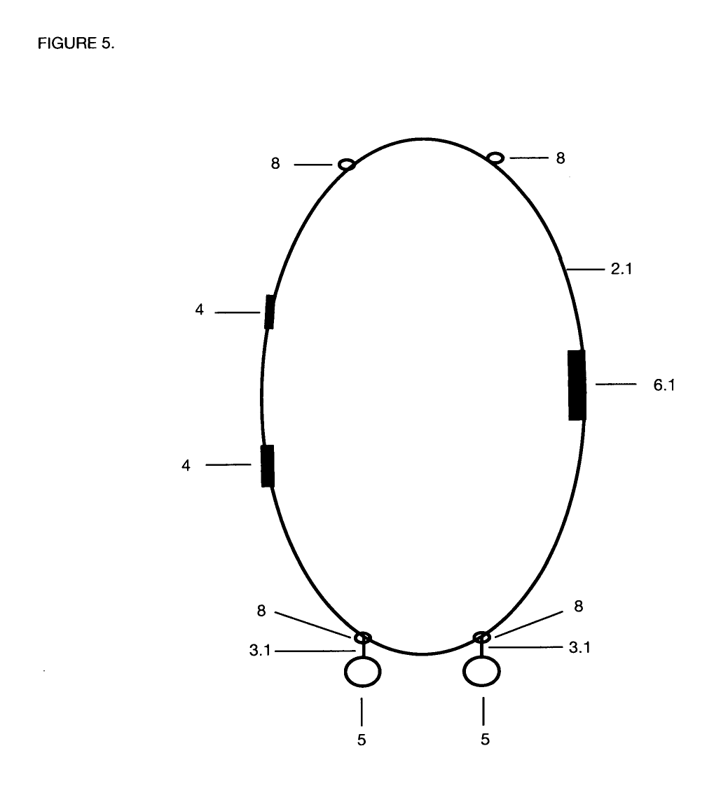

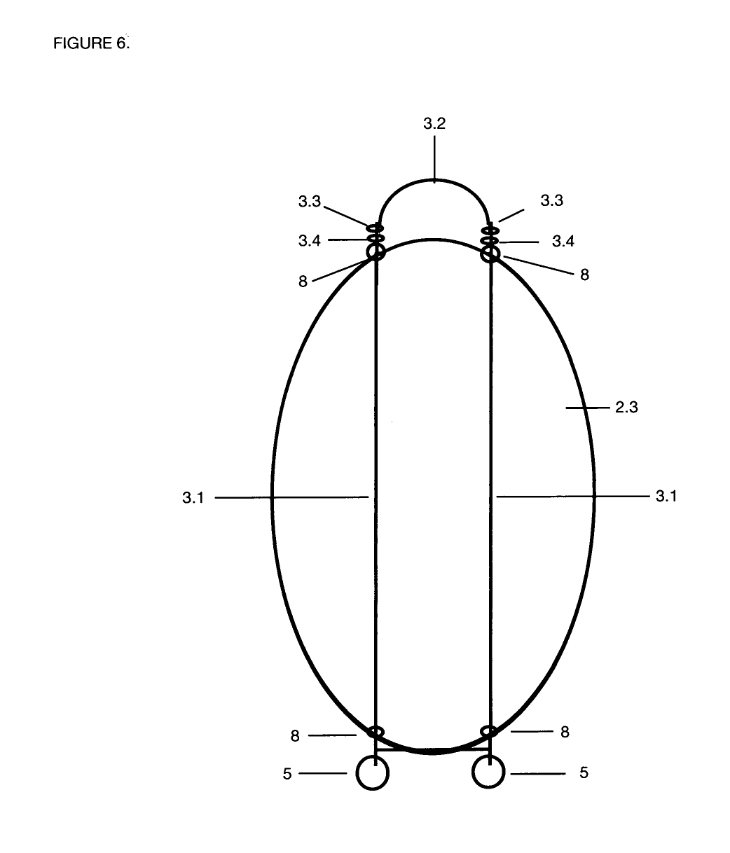

FIG. 1 is from Prototype A an is an attempt to show every aspect of the device with the exceptions being the inner side of the bottom plastic piece called 2.3 is not shown here but can be seen in FIG. 6 and the back side of the bottom piece known as 2.1 is shown in FIG. 5.

The element marked 1 represents the top plastic piece of the device is 13 inches in length, oval until the 13th inch mark where it becomes a straight perpendicular line across the top. This piece is can be seen in FIGS. 1, 2, 3, 4, 16.

Element marked 1.1 shows the Lid's middle aspect which has perpendicular flat edges at either ends and a curved piece on top of the device; it is 11.5 inches in length (both edges in length are flat) and 3.2 inches in width, the top of this plastic is 4.325 inches from the base and is curved at about 108 degrees and can be seen in FIGS. 1, 2, 3, 4, 16.

Element marked 1.2 marks the element at the top end of the outward curve that is a cutting the center of 1.75 inch rectangular cut that allows the top lid to fit over the oxygen tanks nipple and can be seen in FIGS. 1, 2, 3, 4, 16.

Element 2 refers to the bottom piece of plastic and show here the top piece of oval plastic that is flat against the foam and continues to cover the sides and back of the device and can be seen in FIGS. 1, 2, 3, 4, 16.

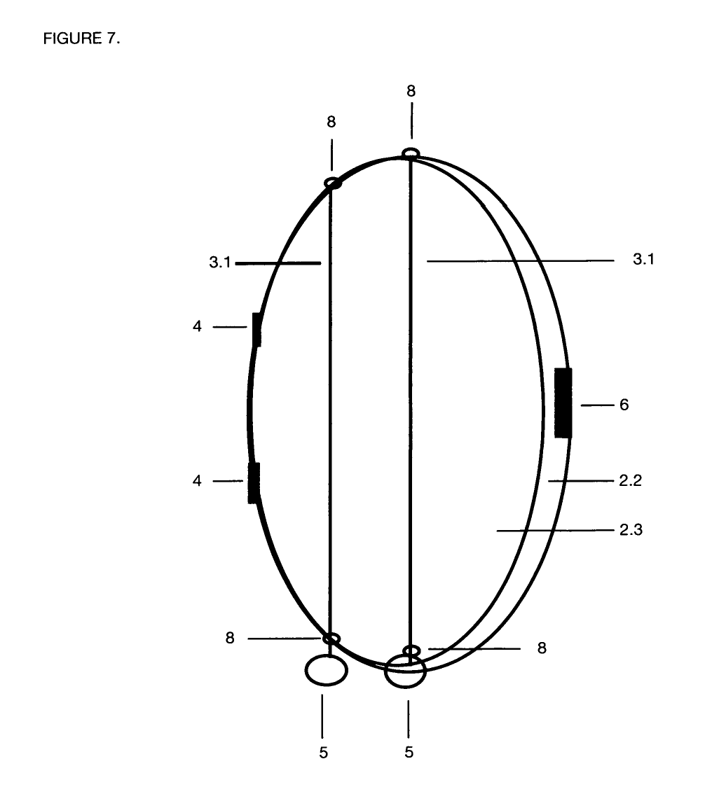

Element 2.2 can be seen in FIGS. 1, 7.

Element 3 refers to the top view of the upper rod of the Transport mechanism when unexpanded and can be be seen in FIGS. 1, 3, 9, 10, 16.

Element 3.1 which represents the larger hollow rod that forms an open bottom rectangle and is glued to the inside of the bottom plastic piece as illustrated in FIGS. 1, 5, 6, 7, 8, 9, 10, 16.
Element 3.2 which represents the handle aspect of the top rod marked 3 can be seen in FIGS. 1, 2, 3, 4, 6, 8, 9, 10, 16.
Element 3.3 represents the retractable nubs that click into place when the Transport mechanism is expanded can be seen in FIGS. 1, 3, 6, 8, 9, 10, 16.
Element 3.4 represents the parallel receptacle holes that are found on the top of the lower rod element that is marked as 3.1. This element can be found in FIGS. 1, 3, 6, 8, 9, 10, 16.
The Element marked as 3.5 represents the buttons on the outside of the handle that push the nubs in so the upper rod and handle marked as 3 and 3.2. This Element can be found in FIGS. 1, 3, 6, 8, 9, 10, 16.

Element 4 representing the hinge systems can be found in FIGS. 1, 2, 3, 4, 5, 7, 15, 16.

Element 5 represents the wheels (which are connected to the larger rod of the Transporter device marked 3.1) can be seen in FIGS. 1, 2, 3, 4, 5, 6, 7, 8, 9, 10, 11, 16.
Element 6 represents the clasp system and can be seen in FIGS. 1, 2, 3, 4, 7, 14, 16.

Element 7 represents the top of the foam board which bottom side is glued to the inside bottom piece (FIG. 5) consists of closed cell foam piece and is oval in shape and is 17 inches in length and 11.5 inches in width and 1.5 inches in depth. The top of the board can also be found in FIGS. 1, 4, 12, 16. It is made of closed cell foam board labeled 7.

Element 7.2 demonstrates the hole in the foam where the portable oxygen tank B will be placed and is further described as follows: It is 2.5 inch wide by 11.5 inch long inverted hole/curve, of approximately 108 degree angle that is 0.5 inches deep, perpendicular at its length edges. These elements can also be found in FIGS. 1, 4, 12, 16.

Element 7.1 represents the back side of the foam board and has the element mark 7.3 are found in FIGS. 1, 13, 16, which represents the two 17 inch in length and 6 inches parallel width, 3/16ths inch in diameter, curved inward indentations/cuts that will allow the handle device to fit snugly so the foam can be glued flat over the inside bottom plastic piece marked 2.3 which can be seen in FIGS. 6, 7, 16.

Element marked as 8 represents the small circular holes in the top and bottom plastic pieces where the upper (3) and lower rods from 3.1 will extend for the wheels (5) to be placed. Element 8 can also be seen in Prototype A's FIGS. 1, 3, 5, 6, 7, 16.

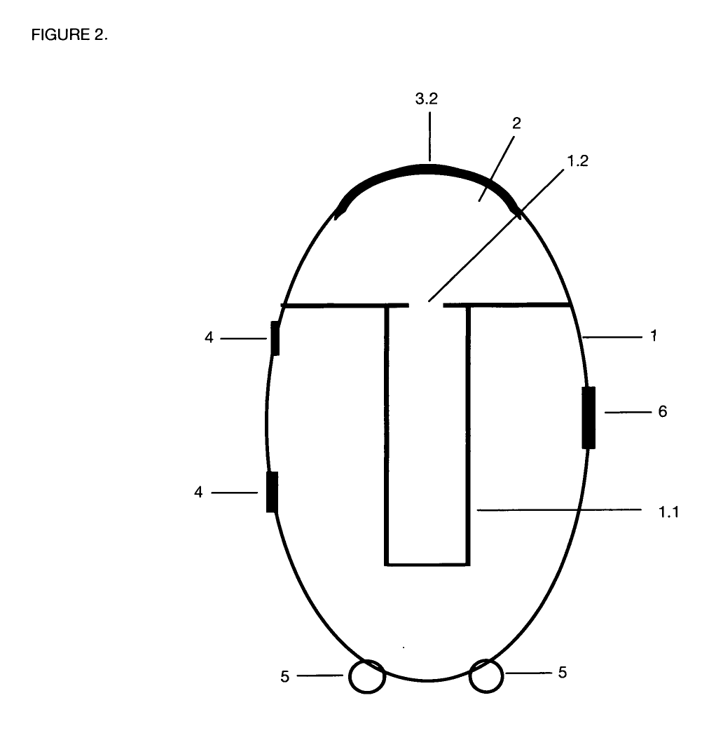

FIG. 2 is the top view of the device listing each of the particular pieces and elements as follows: 1 is the top piece of plastic of the device. The lid is 13 inches in length, oval until the 13th inch mark where it becomes a straight perpendicular line across the top. This element can also be seen in FIGS. 1, 2, 3, 4, 16.

1.1 is the plastic part in the center of top of the device and is 11.5 inches in length (both edges in length are flat) and 2.5 inches in width, the top of this plastic is 4.325 inches from the base and is curved at about 108 degrees. This element can also been seen in FIGS. 1, 2, 3, 4, 16. 1.2 refers to a 1 and ¾ inch wide hole in the top edge of the plastic piece referred to as 1.1, the top of the hole begins at 3.325 inches from the base of the device, which allows room for the plastic cover to evenly cover the top of the portable tank making room for the metal tip so the cover goes all the way to the foam board.
The elements from 1.2 can be seen in FIGS. 1, 2, 3, 4, 16.

2 refers to the bottom piece of plastic and show here the top piece of oval plastic that is flat against the foam and continues to cover the sides and back of the device. This element can also be seen in FIGS. 1, 2, 3, 4, 16.

3.2 refers to the top view of the handle of the Transport mechanism when unexpanded and can be seen in FIGS. 1, 2, 3, 4, 6, 8, 9, 10, 16.

3.3 represents the retractable nubs that click into place when the Transport mechanism is expanded can be seen in FIGS. 1, 3, 6, 8, 9, 10, 16.
4 refers to the top view of the hinge which can be found in FIGS. 1, 2, 3, 4, 5, 7, 15, 16.
5 refers to the wheels connected to the handle piece and are also found in FIGS. 1 2, 3, 4, 5, 6, 7, 8, 9, 10, 11, 16.
6 is the top of the Clasp which can be seen in, FIGS. 1, 2, 3, 4, 7, 14, 16.

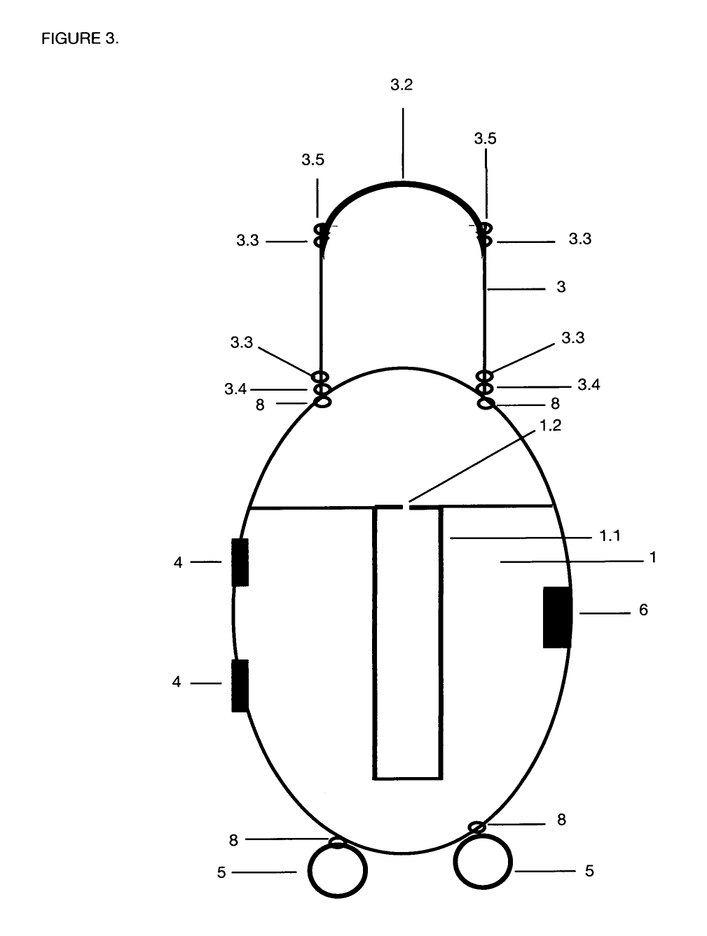

FIG. 3 is the top view of the device with its Transport mechanism expanded listing each of the particular pieces and elements as follows: 1 is the top piece of plastic of the device. The lid is 13 inches in length, oval until the 13th inch mark where it becomes a straight perpendicular line across the top. This element can also be seen in FIGS. 1, 2, 3, 4, 16.

1.1 is the plastic part in the center of top of the device and is 11.5 inches in length (both edges in length are flat) and 2.5 inches in width, the top of this plastic is 4.325 inches from the base and is curved at about 108 degrees. This element can also been seen in FIGS. 1, 2, 3, 16. 1.2 refers to a 1 and ¾ inch wide hole in the top edge of the plastic piece referred to as 1.1, the top of the hole begins at 3.325 inches from the base of the device, which allows room for the plastic cover to evenly cover the top of the portable tank making room for the metal tip so the cover goes all the way to the foam board.

The elements from 1.2 marks the element at the top end of the outward curve that is a cutting the center of 1.75 inch rectangular cut that allows the top lid to fit over the oxygen tanks nipple and can be seen in FIGS. 1, 2, 3, 4, 16.

2 refers to the bottom piece of plastic and show here the top piece of oval plastic that is flat against the foam and continues to cover the sides and back of the device. This element can also be seen in FIGS. 1, 2, 3, 4, 16.

3 refers to the top view of the Transport mechanism when expanded it reaches 32 inches in length and can be seen in FIGS. 1, 3, 9, 10, 16.

3.2 refers to the handle aspect of the upper rod (3) seen in FIGS. 1, 2, 3, 4, 6, 8, 9, 10, 16.
3.3 refers to the retractable nubs that click into place when the Transport mechanism is expanded can be seen in FIGS. 1, 3, 6, 8, 9, 10, 16.
Element 3.4 represents the parallel receptacle holes that are found on the top of the lower rod element that is marked as 3.1. This element can be found in FIGS. 1, 3, 6, 8, 9, 10, 16.
The Element marked as 3.5 represents the buttons on the outside of the handle that push the nubs in so the upper rod and handle marked as 3 and 3.2.

4 refers to the top view of the hinge which can be found in FIGS. 1, 2, 3, 4, 5, 7, 15, 16.

The Element 5 refers to the wheels connected to the handle piece and are also found in FIGS. 1 2, 3, 4, 5, 6, 7, 8, 9, 10, 11, 16.
Element 6 is the top of the Clasp which can be seen in, FIGS. 1, 2, 3, 4, 7, 14, 16.

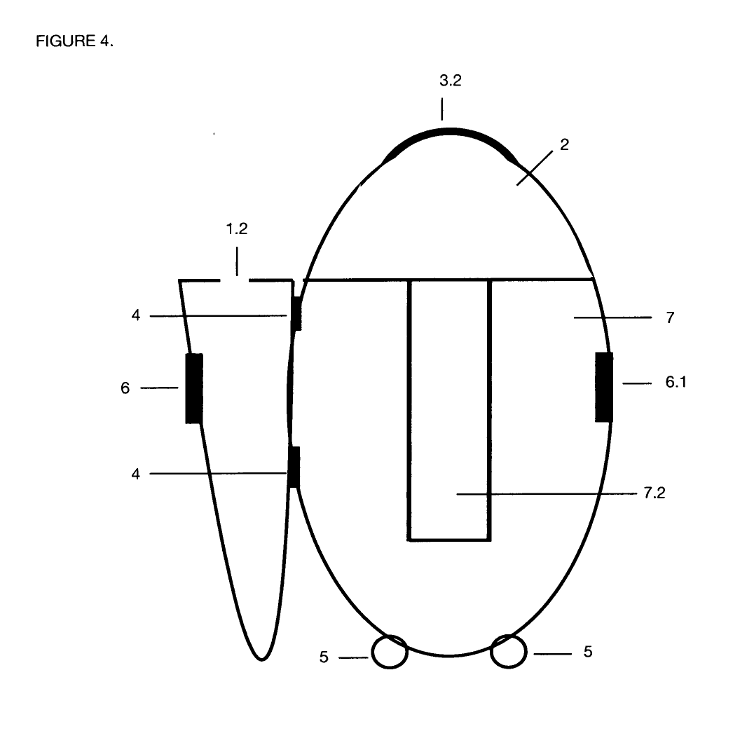

FIG. 4 shows the device with its lid open and includes the following elements: 1 is the top piece of plastic of the device. The lid is 13 inches in length, oval until the 13th inch mark where it becomes a straight perpendicular line across the top. This element can also be seen in FIGS. 1, 2, 3, 4, 16.

Element marked 1.2 marks the element at the top end of the outward curve that is a cutting the center of 1.75 inch rectangular cut that allows the top lid to fit over the oxygen tanks nipple and can be seen in FIGS. 1, 2, 3, 4, 16.

The element marked as 2 can be seen in FIGS. 1, 2, 3, 4, 16. 2 refers to the bottom piece of plastic and show here the top piece of oval plastic that is flat against the foam and continues to cover the sides and back of the device.

The Element marked 3.2 refers to the handle aspect of the upper rod (3) seen in FIGS. 1, 2, 3, 4, 6, 8, 9, 10, 16.
4 refers to the top view of the hinge which can be found in FIGS. 1, 2, 3, 4, 5, 7, 15, 16 The Element 5 refers to the wheels connected to the handle piece and are also found in FIGS. 1 2, 3, 4, 5, 6, 7, 8, 9, 10, 11,16.
Element 6 is the top of the Clasp which can be seen in, FIGS. 1, 2, 3, 4, 7, 14, 16.
Element 6.1 represents the bottom clasp piece found in FIGS. 4, 5, 14, 16.

Element 7 represents the top of the foam board which bottom side is glued to the inside bottom piece (FIG. 5) consists of closed cell foam piece and is oval in shape and is 17 inches in length and 11.5 inches in width and 1.5 inches in depth. The top of the board can also be found in FIGS. 1, 4, 12, 16. It is made of closed cell foam board labeled 7.

Element 7.2 demonstrates the hole in the foam where the portable oxygen tank B will be placed and is further described as follows: It is 2.5 inch wide by 11.5 inch long inverted hole/curve, of approximately 108 degree angle that is 0.5 inches deep, perpendicular at its length edges. These elements can also be found in FIGS. 1, 4, 12, 16.

FIG. 5 represents the back side of the plastic piece of the device labeled 2.1 which can be seen in FIGS. 5, 16.

4 represents the two hinges which can be seen in FIGS. 5, 12, 14.
5 represents the wheels connected to the bottom larger rod marked as 3.1 and are also found in FIGS. 1, 2, 3, 4, 5, 6, 7, 8, 9, 14,16.
6.1 refers to the bottom clasp that is connected to the bottom plastic piece referred to as 2.1. and can be found in FIGS. 4, 5, 14, 16.
8 refers to the small circular holes 3/16ths of an inch in diameter found in both the top and bottom pieces of plastic carrier for Prototype A and are also seen in FIGS. 1, 3, 5, 6, 7, 16.

FIG. 6 represents the inside of the bottom plastic case which is labeled as 2.3 and can be found in FIGS. 6, 7, 16.

3 represents the upper rod that is slightly smaller in diameter ( 2/16ths of an inch) and is in the retractable position this element can be found in FIGS. 1, 3, 9, 10, 16.

3.1 represents the larger and base circular rod piece of the handle mechanism. This bottom half of the handle is slightly larger in diameter ( 3/16ths of an inch) than the rest of the handle ( 2/16ths of an inch) so that the handle rod that expands can move freely into the expanded position. This element can be seen in FIGS. 1, 5, 6, 7, 8, 9, 10, 16. This larger diameter hollow rod continues as one piece that is the base of the Transporter device and connects with the wheels marked as 5 which can be seen in FIGS. 1, 2, 3, 4, 5, 6, 7, 8, 9, 10, 11, 16.

The top half of the mechanism is the rod that expands marked as 3 (reaches 32 inches in length) which is not glued to the plastic so that it can expand freely; it clicks into place when it reaches the top of its extension into the parallel receptacle holes 3.4.

The Element marked 3.2 refers to the handle aspect of the upper rod (3) seen in FIGS. 1, 2, 3, 4, 6, 8, 9, 10, 16.

3.3 represents the retractable nubs that click into place when the Transport mechanism is expanded can be seen in FIGS. 1, 3, 6, 8, 9, 10, 16.

Elements 3.4 represents the parallel receptacle holes that are found on the top of the lower rod element that is marked as 3.1. This element can be found in FIGS. 1, 3, 6, 8, 9, 10, 16.

8 refers to the small circular holes 3/16ths of an inch in diameter found in both the top and bottom pieces of plastic carrier for Prototype A and are also seen in FIGS. 1, 3, 5, 6, 7, 16.

FIG. 7 is a side angled view of the plastic edge which is labeled here as 2.2 which can also be seen in FIGS. 1, 7; and its inner bottom plastic piece referred to as 2.3 and can be seen in FIGS. 6, 7, 16.

4 refers to the top view of the hinge which can be found in FIGS. 1, 2, 3, 4, 5, 7, 15, 16.
5 represents the wheels that are attached to 3.1 and is found in FIGS. 1, 2, 3, 4, 5, 6, 7, 8, 9, 10, 11, 16.
6 is the top of the Clasp which can be seen in FIGS., 1, 2, 3, 4, 7, 14, 16.

8 is the mark for the two small round holes in the plastic ( 3/16ths of an inch) to make room for the Transport mechanism 3.1 rod to extend into its wheels (5). The element 8 can be seen in FIGS. 1, 5, 6, 7, 16.

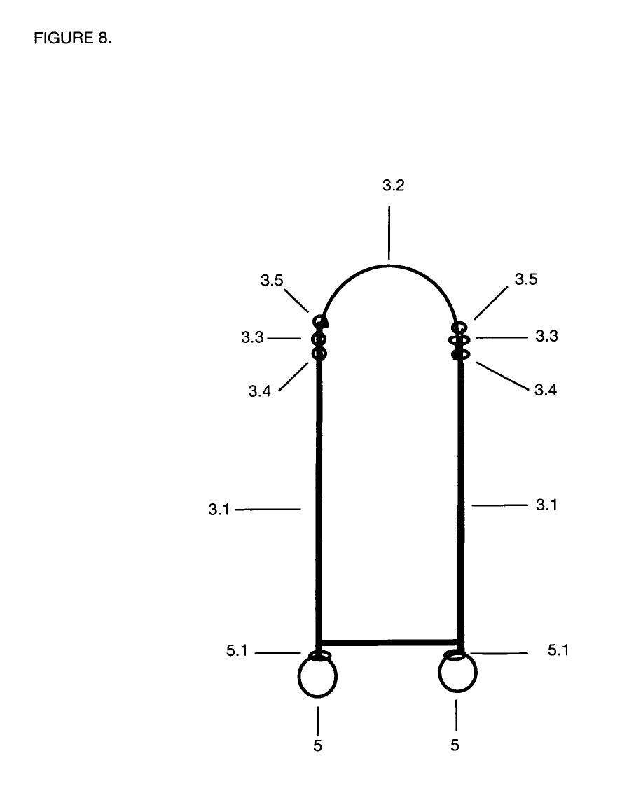

FIG. 8 represents the Transport mechanism alone, with its upper rod, labeled 3, not extended. (It is 18 inches when not expanded)

3 represents the handle that is slightly smaller in diameter ( 2/16ths of an inch) and is in the retractable position. This element can be found in FIGS. 1, 3, 9, 10, 16.

3.1 represents the larger and base circular rod piece of the handle mechanism. This bottom half of the handle is slightly larger in circumference ( 3/16ths of an inch) than the upper rod, 3 ( 2/16ths of an inch) so that the upper rod that expands can move freely into the expanded position. (When expanded it is 32 inches in length) This larger circumference hollow rod marked as 3.1 continues as one piece that is the base of the Transporter device and this element can be found in FIGS. 1, 5, 6, 7, 8, 9, 10, 16. 3.1 connects with the wheels marked as 5 which can be seen in FIGS. 1, 2, 3, 4, 5, 6, 7, 8, 9, 10, 11, 16. 3.2 refers to the handle aspect of the upper rod (3) seen in FIGS. 1, 2, 3, 4, 6, 8, 9, 10, 16.

3.3 represents the retractable nubs that click into place when the Transport mechanism is expanded can be seen in FIGS. 1, 3, 6, 8, 9, 10, 16.

Element 3.4 represents the parallel receptacle holes that are found on the top of the lower rod element that is marked as 3.1. This element can be found in FIGS. 1, 3, 6, 8, 9, 10, 16.

Element marked as 3.5 represents the buttons on the outside of the handle that push the nubs in so the upper rod and handle marked as 3 and 3.2. This Element can be found in FIGS. 1, 3, 6, 8, 9, 10, 16.

The Element marked as 5, wheels which are preceded by the swivel 5.1, all of which is one piece with 3.1, can be seen in FIGS. 1, 2, 3, 4, 5, 6, 7, 8, 9, 10, 11, 16.

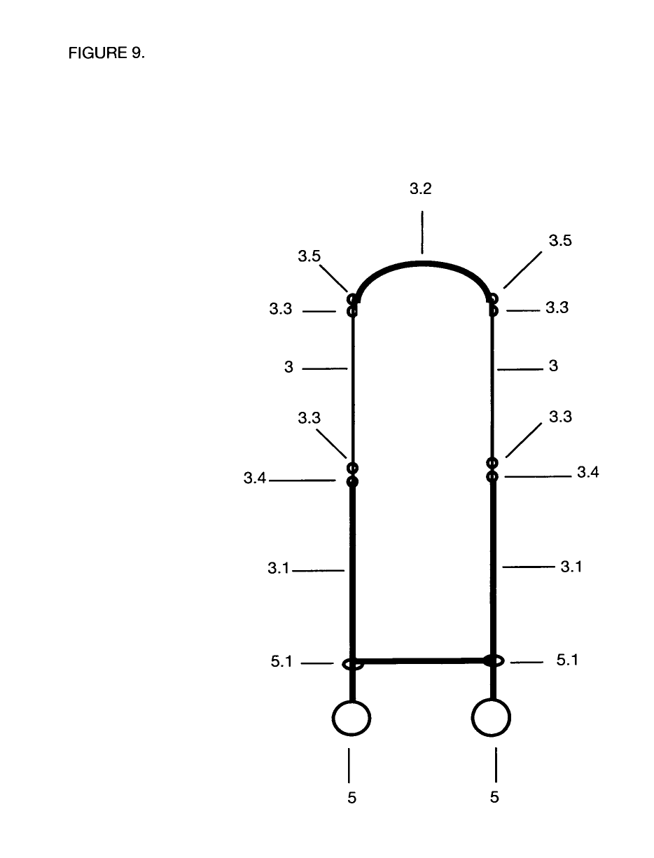

FIG. 9 illustrates the Transport mechanism as expanded (It expands to 32 inches). 3 is expanded out of 3.1 and it is possible to see the spring metal nobs labeled as 3.3 that have clicked through the holes marked as 3.4 at the top of 3.1.

3 represents the handle that is slightly smaller in diameter ( 2/16ths of an inch) and is in the retractable position. This element can be found in FIGS. 1, 3, 9, 10, 16. 3.1 represents the larger and base circular rod piece of the handle mechanism. This bottom half of the handle

3.1 is slightly larger in circumference ( 3/16ths of an inch) than the upper rod 3 ( 2/16ths of an inch) so that the upper rod that expands can move freely into the expanded position. (When expanded it is 32 inches in length) This larger circumference hollow rod marked as 3.1 continues as one piece that is the base of the Transporter device and this element can be found in FIGS. 1, 5, 6, 7, 8, 9, 10, 16. 3.1 connects with the wheels marked as 5 which can be seen in FIGS. 1, 2, 3, 4, 5, 6, 7, 8, 9, 10, 11, 16.

3.2 refers to the handle aspect of the upper rod (3) seen in FIGS. 1, 2, 3, 4, 6, 8, 9, 10, 16.
3.3 represents the retractable nubs that click into place when the Transport mechanism is expanded can be seen in FIGS. 1, 3, 6, 8, 9, 10, 16.

Element 3.4 represents the parallel receptacle holes that are found on the top of the lower rod element that is marked as 3.1. This element can be found in FIGS. 1, 3, 6, 8, 9, 10, 16.

The Element marked as 3.5 represents the buttons on the outside of the handle that push the nubs in so the upper rod and handle marked as (3) and (3.2) can expand. This Element (3.5) can be found in FIGS. 1, 3, 6, 8, 9, 10, 16.
The Element marked as 5, wheels, which are preceded by the swivel 5.1, all of which is one piece with 3.1, can be seen in FIGS. 1, 2, 3, 4, 5, 6, 7, 8, 9, 10, 11, 16.

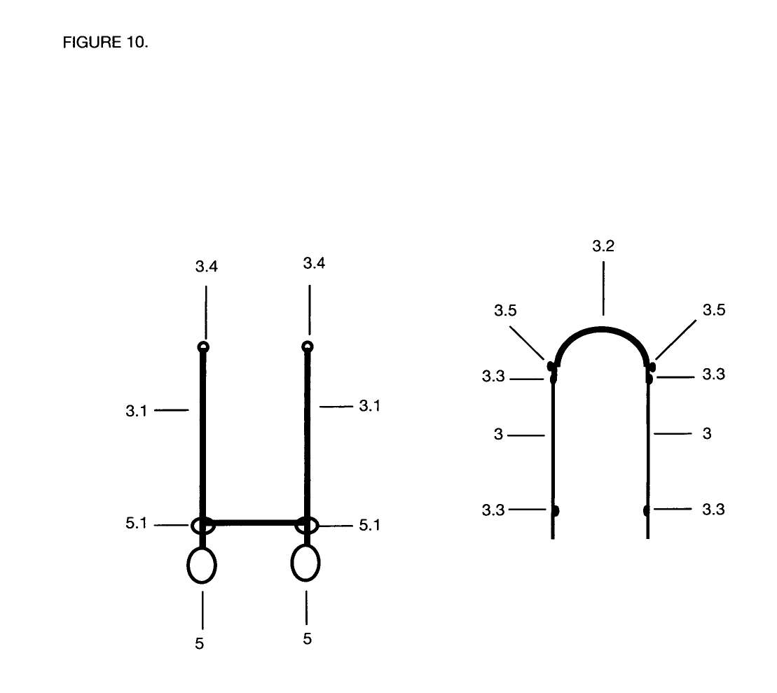

FIG. 10 shows both the lower rod (3.1) with its Elements: 3.4 which shows the parallel receptacle holes that are found on the top of the lower rod element that is marked as 3.1. This element can be found in FIGS. 1, 3, 6, 8, 9, 10, 16.

The Element marked as 5, wheels which are preceded by the swivel (5.1) all of which is one piece with 3.1, can be seen in FIGS. 1, 2, 3, 4, 5, 6, 7, 8, 9, 10, 11, 16. second drawing is of the upper rod known as 3 represents the upper rod that is slightly smaller in diameter ( 2/16ths of an inch) and can be found in FIGS. 1, 3, 9, 10, 16.
3.2 refers to the handle aspect of the upper rod (3) seen in FIGS. 1, 2, 3, 4, 6, 8, 9, 10, 16.
3.3 represents the retractable nubs that click into place when the Transport mechanism is expanded can be seen in FIGS. 1, 3, 6, 8, 9, 10, 16.

FIG. 11 is a drawing of the wheel 5, which is preceded by the swivel 5.1, which comes out of the lower rod, 3.1.

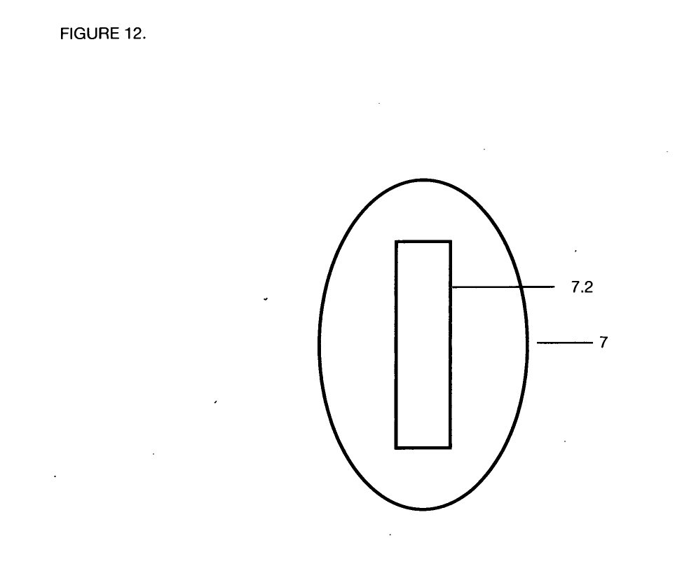

FIG. 12 is a view of the top side of the foam board, marked as 7 which bottom side is glued to the inside bottom piece FIG. 5. The top of the board can also be found in FIG. 4 marked as 7 and 7.2. It is made of closed cell foam board labeled 11. The closed cell foam piece is oval in shape and is 17 inches in length and 11.5 inches in width and 1.5 inches in depth.

The label 7.2 demonstrates the hole in the foam where the portable oxygen tank B will be placed and is further described as follows: It is 2.5 inch wide by 11.5 inch long inverted hole/curve, of approximately 108 degree angle that is 0.5 inches deep, perpendicular at its length edges. These elements can also be found in FIGS. 1, 4, 12, 16.

FIG. 13 illustrates the bottom side of the closed cell foam labeled 7.1. 7.3 represents the two 17 inch in length and 6 inch wide perpendicular cut at the base of the board and is 3/16th of an inch in diameter, curved inward indentations/cuts that will allow the handle device to fit snugly so the foam can be glued flat over the inside bottom plastic piece which can be seen in FIGS. 1, 13, 16.

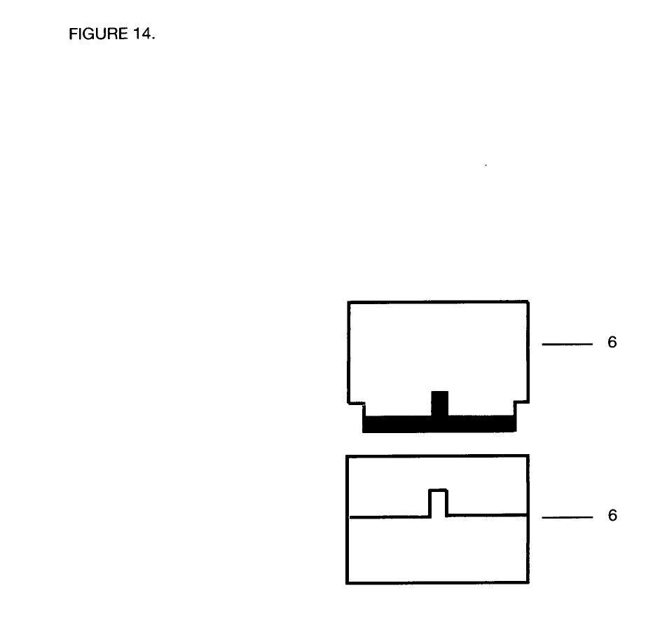

FIG. 14 illustrates the two pieces of clasp that snap the lid down. 6 is the top aspect which is the top piece of plastic clasp that is a part of the top plastic piece known as 1 and listed in FIGS. 1, 2, 3, 4, 7, 14, 16. This piece of clasp measures 3 inches in width and one inch in length. It's depth is 2/8ths of an inch and it connects to the top inside of the plastic edge which has been built out 1 and ⅛th of an inch from the edge of the foam.

6.1 represents the receptacle aspect of the clasp and is located on the bottom piece of the plastic which has been built out by 1 and ⅛th from the edge of the foam. This piece of clasp measures 3 inches in width and one inch in length. It's depth is 2/8ths of an inch. This element can be found in FIGS. 4; 5, 14, 16.

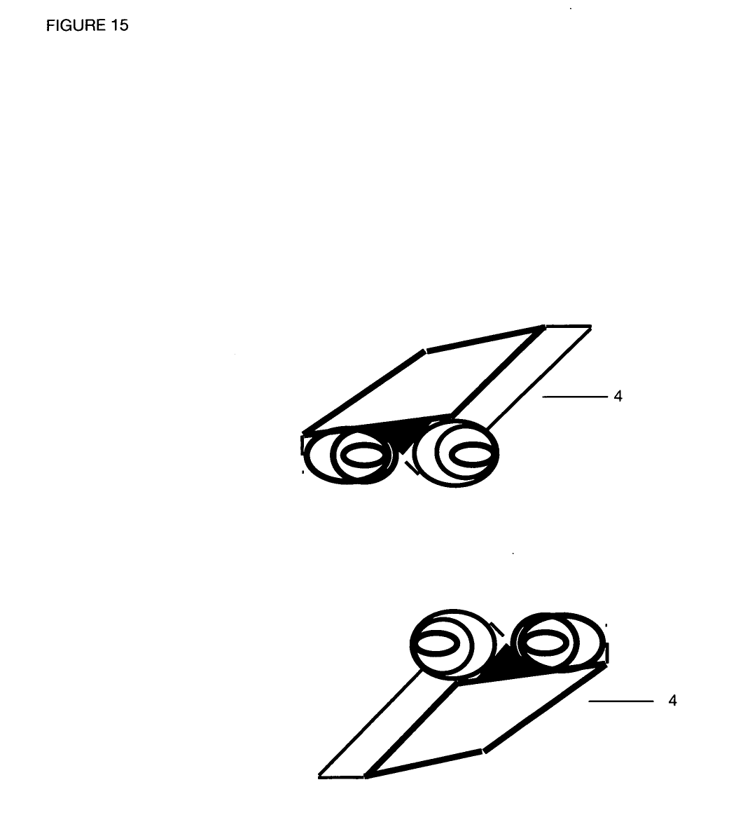

FIG. 15 represents the hinge system marked as 4. Like the clasp system, the hinge system is built out plastic of 1 and ⅛th of an inch from the edge of the foam. It measures 5 inches in length and is ¼th inch in diameter. This drawing shows the top and bottom of the hinge system. There are two sets of hinges with the same measurements which can be seen in FIGS. 1, 2, 3, 4, 5, 7, 15, 16.

FIG. 16 Summary: represents each piece of the device and the whole device put together. First piece is 1 (Top) and 2 (Bottom) whole plastic piece. Second piece is 1 (Top) and 2 (Bottom) and 3 (The Transporter). The third piece 7 is the foam piece with front and back cuts. 1-7 represents the entire device put together.

The first piece shown represents the plastic case in total with its lid open includes the following elements listed: 1 is the top piece of plastic of the device. The lid is 13 inches in length, oval until the 13th inch mark where it becomes a straight perpendicular line across the top and this element can be found in FIGS. 1, 2, 3, 4, 16.

1.1 is the plastic part in the center of top of the device and is 11.5 inches in length (both edges in length are flat) and 2.5 inches in width, the top of this plastic is 4.325 inches from the base and this element can be found in FIGS. 1, 2, 3, 16.
1.2 refers to a 1 and ¾ inch wide hole in the top edge of the plastic piece referred to as 1.1, the top of the hole begins at 3.325 inches from the base of the device, which allows room for the plastic cover to evenly cover the top of the portable tank making room for the metal tip so the cover goes all the way to the foam board. This element can be found in FIGS. 1, 2, 3, 4, 16.

2 refers to the the bottom piece of plastic which includes the connected piece that covers the half moon that is flat against the foam in the shape of a half-moon. This element can be found in FIGS. 1,2,3,4,16.

2.1 which is the back side of the plastic piece and can be found in FIGS. 5,16.
2.2 which is the outer edge of the bottom plastic piece and can be found in FIGS. 1 and 7.
2.3 can be found in FIGS. 6, 7, 16. 4 represents the hinge system which can be seen in FIGS. 1, 2, 3, 4, 5, 7, 15, 16; and 6 and 6.1 represent the clasp system found in FIGS. 1, 2, 3, 4, 5, 7, 14, 16.

The second drawing of FIG. 14 represented shows the second step in putting the device together. The Transporter mechanism marked 3 seen in FIGS. 1, 3, 9, 10, 16, includes a larger hollow rod marked as 3.1 is 3/16ths of an inching diameter that is seen as open on top and is rectangular in shape is seen in FIGS. 1, 5, 6, 7, 8, 9, 10, 16. It has wheels on the base of 3.1 marked as 5 FIGS. 1 2, 3, 4, 5, 6, 7, 8, 9, 10, 11, 16. and the last piece is the smaller rod and handle marked as 3, which is 2/16ths of an inch diameter seen in FIGS. 1, 2, 3, 9, 10, 16; which slides up and snaps into place when extended.

The Transport mechanism is glued flat into the inside plastic piece marked as 2.2 as seen in FIGS. 1 and 7.

The third drawing of FIG. 13 is the foam flotation board marked as 7 as seen in FIGS. 1, 4, 12, 16.

7.2 represents the top view of the hole in the foam where the portable oxygen tank B lies in the middle of the foam; it is 2.5 inch wide by 11.5 inch long inverted hole/curve at 108 degree angle that is 0.5 inches deep, perpendicular at its length edges. This element can be seen in FIGS. 1, 4, 12, 16.
7.1 represents the back of the foam board and 7.3 marks the small tubular parallel indented cuts on the bottom of the foam which allows the foam to fit snuggly on top of the Transporter Mechanism that is glued to the inside bottom of the Plastic Device. These elements can be seen in FIGS. 1, 13, 16.

The fourth and final drawing on FIG. 16 represents the complete device for Prototype A put together with the handle extended.

The device could be in the shape of an oval, a square, a rectangle or a circle. The case could be made of wood or metal products. The plastic materials can be made The plastic could be made from any of the following materials: polypropylene; acrylic; polycarbonate, (PC); Polyethylene, (PETE, PET, PE); polyvinyl chloride (PVC); Acrylonitrile-Butadiene-Styrene, (ABS). The Shape of the plastic cover could be 14 to 25 inches in length, 8 to 25 inches in width, and 1 to 6 inches in depth.

The top cover that curves marked as 1.1 has the following possible shapes and dimensions: The cover could be square, rectangular, cone shaped, circular, and could measure from 8 to 22 inches in length; from 2 to 8 inches in width. The height of the cover could be anywhere from 3 to 15 inches. The cover could cover the regulator or not. The cover could open and close either to the left or right, or top to bottom of the device. The cover could also slide from top to bottom, or from left to right, or right to left.

The hinges could be 1 to 8 inches in length and could connect at any place on the devices edge. The hinge could be built out or flat against the edge of the device. The hinge could be a part of the plastic pieces or a separate piece.

The clasp could be from 1 to 8 inches in length and could be connected to the device as 1 or two pieces. The clasp could be connected to the outer cover or not.

The foam material could be in the shape of a square, a rectangle, a circle, an oval and could be anywhere from 8 to 40 inches in length; 8 to 40 inches in width; and 1 to 10 inches in depth. The foam could be made from the following possible materials: Polyethylene; Cross linked Polyethylene; Polystrene; Neoprene rubber; Gym rubber, Polypropylene foam, styrofoam, or any type of wood material. The foam could be floating freely in the device for removal or as listed, glued into the bottom plastic piece.

The indentation of the top side of the foam could be anywhere from 5 to 40 inches in length, 2.5 to 5 inches in width and 0 to 4 inches in depth. The indentation could have the following dimensions: flat, 0.5, 0.6, 0.7, 0.8, 0.9, 1 inch, 1.5 inches, 3 inches.

The Transporter mechanism could consist of 1, 2, or several different pieces. The handle could be either built into the device or a separate piece and could be made of plastic, wood, or rubber. The length of the handle could be anywhere from 15 and extend to 60 inches in length. The handle and rods could be made of aluminum, steel, copper.

The Transporter mechanism could be built on the outside of the foam or on the outside of the carry piece.

The wheels could be in the form of balls, or circular wheels. The wheels could be made of plastic or rubber. The wheels could be connected to the metal rods as one piece, or they could be connected by using a male, female connection. The wheels could be non moveable and pointed in one and the same direction, or they could float to move with the direction of the cases movement.

### Prototype B

Brief Description:

There are four pieces that make up this device. The first piece is the top plastic piece referred to as 1 known as the lid. Unlike Prototype A it has no hinges. It has a small lip at its base marked as 9, that allows it to seal with the bottom piece of plastic marked as 2 and its lip marked 9.1. The plastic is 2 to 3 8ths in depth and is 13 inches in length, oval until the 13th inch mark where it becomes a straight perpendicular line across the top; and has an outward curve that allows fits snuggly over the top of the portable oxygen tank B. See FIGS. 17, 18, 26.

1.1 shows the Lid's middle aspect which has perpendicular flat edges at either ends and a curved piece on top of the device; it is 11.5 inches in length (both edges in length are flat) and 3.2 inches in width, the top of this plastic is 4.325 inches from the base and is curved at about 108 degrees. See FIGS. 17, 18, 26.

1.2 marks the element at the top end of the outward curve that is a cutting the center of 1.75 inch rectangular cut that allows the top lid to fit over the oxygen tanks nipple.

The second piece of plastic is marked as 2 for the its basic element, 2.3 for the inside depth and 2.1 for the back side. This piece is similar to an oval baking dish and has a depth of 1.5 inches for the foam piece. The plastic could be made from any of the following types of plastics: polypropylene; acrylic; polycarbonate, (PC); Polyethylene, (PETE, PET, PE); polyvinyl chloride (PVC); Acrylonitrile-Butadiene-Styrene, (ABS). See FIGS. 17, 19, 26.

The second piece is the foam piece marked as 7, which measures 17 inches in length and 11.5 inches wide and is 1.5 inches in depth. It is oval in shape. 7.2 represents the angled cut in the center of the foam that starts 1.5 inches from the bottom of the foam, that measures 11.5 inches in length with perpendicular edges; 2.5 inches in width, and the curved depth is 0.5 inches at the center. This curve in the foam allows the portable oxygen tank to sit snuggly on top of the foam. See FIGS. 17, 25, 26. The foam piece could be made of any of the following materials: Polyethylene; Cross linked Polyethylene; Polystyrene; Neoprene rubber; Gym rubber, Polypropylene foam, styrofoam, or any type of wood material. See FIGS.

The third piece is the bottom receptacle piece of plastic marked as 2. It has a small lip around the base of the 15 inch in length circumference that is the bottom plastic piece. This piece of plastic is 2 to ⅜ths thick and, oval in shape length of 15 inches and a width of 11.5 inches with 1.5 inches in depth and holds the similarly shaped foam piece in snuggly. Unlike Prototype A the bottom plastic piece does not come up past the top edge of the device. The back side of this plastic piece, marked as 2.1 has four clips marked 10 and seen in FIGS. 17, 19, 20, 26 on its four corners that hold the fourth piece firmly in place.

The fourth piece of Prototype B is the Transport mechanism which is marked as 3 and 3.1, 5, and 5.1. This mechanism snaps firmly onto the back of the bottom plastic piece (marked as 2.1) and can be removed as desired. The Transport mechanism allows for the device to either be wheeled or hand carried as desired. It expands to the height desired and clicks into place. This piece has two parts. The bottom part that is hollow rod marked as 3.1 and a little larger ( 3/16ths of an inch in diameter and is 18 inches in height), with parallel rods 6 inches apart so the the second smaller bottom rod marked 3 (2.16ths of an inch in diameter and 14 inches in height) both rods being parallel 6 inches apart, can expand easily reaches 32 inches in length. This bottom hollow rod has small retractable nubs that will allow the top rod which has holes to move to the selected height and then snap into place securely; this part also has two wheels attached to it for the Transporters mobility. This can be seen in FIGS. 17, 21, 22, 23, 26.

FIG. 17 represents the entire device known as Prototype B. 1 represents The Lid. as can be seen in FIGS. 17, 18, 26. It has no hinges. It has a small lip at its base marked as 9 that allows it to seal with the bottom piece of plastic piece 2 and its lip edge marked 9.1. The plastic is 2 to 3 8ths in depth and is 13 inches in length, oval until the 13th inch mark where it becomes a straight perpendicular line across the top.

1.1 represents the Lid's middle aspect which has perpendicular flat edges at either ends and a curved piece on top of the device; it is 11.5 inches in length (both edges in length are flat) and 3.2 inches in width, the top of this plastic is 4.325 inches from the base and is curved at about 108 degrees. See FIGS. 17, 18, 26.

1.2 marks the element at the top end of the outward curve that is a cutting the center of 1.75 inch rectangular cut that allows the top lid to fit over the oxygen tanks nipple. See FIGS. 17, 18, 26. 2 has a small lip marked as 9.1 around the base of the 15 inch in length circumference that is the bottom plastic piece. This piece of plastic is 2 to ⅜ths thick and, oval in shape length of 15 inches and a width of 11.5 inches with 1.5 inches in depth and holds the similarly shaped foam piece in snuggly. Unlike Prototype A the bottom plastic piece does not come up past the top edge of the device

2 is similar to an oval baking dish and has a depth of 1.5 inches for the foam piece it can be seen in FIGS. 17, 19, 26.

The back side of this plastic piece, marked as 2.1 has four clips (marked 10) and can be seen in FIGS. 17, 19, 20, 26, on its four corners that hold the fourth piece firmly in place.
3 and 3.1 and 5 the wheels, represent the Transporter mechanism and can be seen in FIGS. 17, 21, 22, 23, 24, 26.

FIG. 24 shows the swivel aspect of the wheels (5). This mechanism snaps firmly into the clips marked as 10 and found in FIGS. 17, 19, 20, 26 which are found on the back of the bottom plastic piece (marked as 2.1) and can be removed as desired.

The Transport Mechanism allows for the device to either be wheeled or hand carried as desired. It expands to the height desired (32 inches possible) and clicks into place. This piece has two parts: the bottom part (3.1) that is hollow and a little larger ( 3/16ths of an inch in diameter) so the the second part (3) ( 2/16ths of an inch in diameter) can expand easily. This bottom hollow rod has small retractable nubs (3.2) that will allow the top rod which has holes to move to the selected height and then snap into place securely; this part also has two wheels (5) attached to it for the Transporters mobility. This can be seen in FIGS. 17, 21, 22, 23, 24, 26.

7 represents the foam piece and can be found in FIGS. 17, 25, 26.
The back marked 7.1 can not be seen here but is in FIGS. 25,26.

7.2 represents the angled cut in the center of the foam that starts 1.5 inches from the bottom of the foam, that measures 11.5 inches in length with perpendicular edges; 2.5 inches in width, and the curved depth is 0.5 inches at the center. This curve in the foam allows the portable oxygen tank to sit snuggly on top of the foam.

9 represents the lip of the top plastic piece that goes over the bottom plastic pieces lip marked 9.1.
10 represents the clips attached to the back of the bottom plastic piece and can be seen in FIGS. 17, 19, 20, 26.

FIG. 18 represents the top half of the device called the Lid marked as 1. It that has no hinges. It has a small lip at its base 9 that allows it to seal with the bottom piece of plastic. Element 9 can be seen in FIGS. 17, 18, 26. The plastic top and bottom case are ⅛th of an inch thick. The top plastic piece marked as 1 is 13 inches in length, oval until the 13th inch mark where it becomes a straight perpendicular line across the top; and has an outward curve marked 1.1 that allows the Lid to fit snuggly over the top of the portable oxygen tank B. For Element 1 see FIGS. 17, 18, 26.

1.1 shows the Lid's middle aspect which has perpendicular flat edges at either ends and a curved piece on top of the device; it is 11.5 inches in length (both edges in length are flat) and 3.2 inches in width, the top of this plastic is 4.325 inches from the base and is curved at about 108 degrees. See FIGS. 17, 18, 26.
1.2 marks the element at the top end of the outward curve that is a cutting the center of 1.75 inch rectangular cut that allows the top lid to fit over the oxygen tanks nipple. This element can be seen in FIGS. 17, 18, 26.

FIG. 19 represents the bottom plastic piece of the device marked as 2 which represents the top part of the bottom plastic piece which is similar to an oval baking dish and has a depth of 1.5 inches for the foam piece. 2.1 demonstrates the back side of the bottom receptacle plastic piece. In the area of 2.1 you can see the bottom lip (9) and the four clips marked as 10, that are attached to the backside of the bottom piece in the four corners. Element 9 can also be seen in 17, 18, 26. Element 10 can also be seen in FIGS. 15, 17, 18, 22.

FIG. 20 represents a clip marked as 10 which can be seen in FIGS. 17, 19, 20, 26

FIG. 21 represents the Transporter mechanism as unexpanded (length is 18 inches). This mechanism snaps firmly onto the back of the bottom plastic piece and can be removed as desired. The Transporter Mechanism allows for the device to either be wheeled or hand carried as desired. It expands to the height desired (up to 32 total inches) and clicks into place. This piece has two parts. The bottom part, 3.1 is hollow and a little larger 3/16ths of an inch in diameter, so the the second lower rod (3), which is only 2/16ths of an inch in diameter, can expand easily. This bottom hollow rod, 3.1 has small holes marked as 3.4 that will receive the nubs 3.3 found in the upper part, a rod 3, and can be seen in FIGS. 17, 21, 22, 23, 26. When the nubs are retracted because they have been depressed by the side handle's buttons 3.5, this will allow the top rod to move to the selected height and then snap into those same holes 3.4, on the top of 3.1 place securely; this part also has two wheels (5) attached to it for the Transporters mobility. These can be seen in FIGS. 17, 21 22, 23, 24, 26.

FIG. 22 represents the Transporter mechanism as expanded whose length is 32 inches. This mechanism snaps firmly onto the back of the bottom plastic piece and can be removed as desired. The Transport Mechanism allows for the device to either be wheeled or hand carried as desired. It expands to the height desired (up to 32 total inches) and clicks into place. This piece has two parts. The bottom part, 3.1 is hollow and a little larger 3/16ths of an inch in diameter, so the the second lower rod (3), which is only 2/16ths of an inch in diameter, can expand easily. This bottom hollow rod, 3.1 has small holes marked as 3.4 that will receive the nubs 3.3 found in the upper rod 3, and can be seen in FIGS. 17, 21, 22, 23, 26. When the nubs are retracted because they have been depressed by the side handle's buttons 3.5, this will allow the top rod to move to the selected height and then snap into those same holes 3.4, on the top of 3.1 place securely; this part also has two wheels (5) attached to it for the Transporters mobility. These can be seen in FIGS. 17, 21 22, 23, 24, 26.

FIG. 23 shows both the lower rod (3.1) and the upper rod (3) with their Elements: 3.1 is the bottom half and has the following elements: 3.4 which shows the parallel receptacle holes that are found on the top of the lower rod element that is marked as 3.1. This element can be found in FIGS. 17, 21, 22, 23, 26. The Element marked as 5 is the wheels which are preceded by the swivel (5.1) all of which is one piece with 3.1, and can be seen in FIGS. 17, 21, 22, 23, 24, 26.

The second drawing is of the upper rod known as 3, that is slightly smaller in diameter ( 2/16ths of an inch) and can be found in FIGS. 17, 21, 22, 23, 26. 3.2 refers to the handle aspect of the upper rod (3) seen in FIGS. 17, 21, 22, 23, 26. 3.3 represents the retractable nubs that click into place when the Transport mechanism is expanded can be seen in FIGS. 17, 21, 22, 23, 26.

3.5 represents the outer buttons of the handle, marked 3.2 which when pressed in, depress the nobs, marked 3.3 and allow the upper rod to expand to its complete length and then click into place in the holes on 3.1, marked 3.4.

FIG. 24 represents the wheels marked as 5 and the swivel device marked as 5.1 for each of the wheels. The swivel device allows the wheels to move in any direction. The wheels can also be seen in FIGS. 17, 21, 22, 23, 24, 26.

FIG. 25 show drawings of the top (7) and the back side (7.1) of the foam board. The foam board measures 17 inches in length and 11.5 inches wide and is 1.5 inches in depth. 7.2 represents the angled cut in the center of the foam that starts 1.5 inches from the bottom of the foam, that measures 11.5 inches in length with perpendicular edges; 2.5 inches in width, and the curved depth is 0.5 inches at the center. This curve in the foam allows the portable oxygen tank to sit snuggly on top of the foam. See FIGS. 17, 25, 26.

FIG. 26 best demonstrates how the individual pieces will be put together. The first drawing is the top lid. The second drawing is the bottom receptacle. The third drawing is the foam piece, which fits snuggly into the previous pictured bottom plastic piece. The fourth drawing shows the Transporter mechanism attached to the back of the bottom plastic piece to complete the device as the first drawing. The top plastic lid is placed over the top of the portable oxygen tank B, and snaps into place connecting with the bottom plastic piece.

The device could be in the shape of an oval, a square, a rectangle or a circle. The case could be made of wood or metal products. The plastic could be made from any of the following materials: polypropylene; acrylic; polycarbonate, (PC); Polyethylene, (PETE, PET, PE); polyvinyl chloride (PVC); Acrylonitrile-Butadiene-Styrene, (ABS). The Shape of the plastic cover could be 14 to 25 inches in length, 8 to 25 inches in width, and 1 to 6 inches in depth.

The top cover that curves marked as 1.1 has the following possible shapes and dimensions: The cover could be square, rectangular, cone shaped, circular, and could measure from 8 to 22 inches in length; from 2 to 8 inches in width. The height of the cover could be anywhere from 3 to 15 inches. The cover could cover the regulator or not. The cover could open and close either to the left or right, or top to bottom of the device. The cover could also slide from top to bottom, or from left to right, or right to left.

The foam material could be in the shape of a square, a rectangle, a circle, an oval and could be anywhere from 8 to 40 inches in length; 8 to 40 inches in width; and 1 to 10 inches in depth. The foam could be made from the following possible materials: Polyethylene; Cross linked Polyethylene; Polystrene; Neoprene rubber; Gym rubber, Polypropylene foam, styrofoam, or any type of wood material. The foam could be floating freely in the device for removal or as listed, glued into the bottom plastic piece.

The indentation of the top side of the foam could be anywhere from 5 to 40 inches in length, 2.5 to 5 inches in width and 0 to 4 inches in depth. The indentation could have the following dimensions: flat, 0.5, 0.6, 0.7, 0.8, 0.9, 1 inch, 1.5 inches, 3 inches.

The Transporter mechanism could consist of 1, 2, 3, 4 different pieces. The upper rod could have a built in handle at its top which could be made of rubber of rubber of plastic. The length of the upper rod could be anywhere from 15 and extend to 60 inches in length. The rods could be made of aluminum, steel, copper. The Transporter mechanism could be built on the outside of the foam or on the outside of the carry piece.

The wheels could be in the form of balls, or circular wheels. The wheels could be made of plastic or rubber. The wheels could be connected to the metal rods as one piece, or they could be connected by using a male, female connection. The wheels could be non moveable and pointed in one and the same direction, or they could float to move with the direction of the cases movement.

### The Process of Making it and how the Pieces Fit Together

For Prototype A FIG. 16 Summary: represents each piece of the device and the whole device put together. First piece is 1 (Top) and 2 (Bottom) whole plastic piece. Second piece is 1 (Top) and 2 (Bottom) and 3 (The Transporter). The third piece 7 is the foam piece with front and back cuts. 1-7 represents the entire device put together. The first piece shown represents the plastic case in total with its lid open includes the following elements listed: 1 is the top piece of plastic of the device. The lid is 13 inches in length, oval until the 13th inch mark where it becomes a straight perpendicular line across the top and this element can be found in FIGS. 1, 2, 3, 4, 16.

1.1 is the plastic part in the center of top of the device and is 11.5 inches in length (both edges in length are flat) and 2.5 inches in width, the top of this plastic is 4.325 inches from the base and this element can be found in FIGS. 1, 2, 3, 16.

1.2 refers to a 1 and ¾ inch wide hole in the top edge of the plastic piece referred to as 1.1, the top of the hole begins at 3.325 inches from the base of the device, which allows room for the plastic cover to evenly cover the top of the portable tank making room for the metal tip so the cover goes all the way to the foam board. This element can be found in FIGS. 1, 2, 3, 4, 14.

2 refers to the the bottom piece of plastic which includes the connected piece that covers the half moon that is flat against the foam in the shape of a half-moon. This element can be found in FIGS. 1, 2, 3, 4, 16.

2.1 which is the back side of the plastic piece and can be found in FIGS. 5, 16.
2.2 which is the outer edge of the bottom plastic piece and can be found in FIGS. 1 and 7.
2.3 can be found in FIGS. 6, 7, 16.
4 represents the hinge system which can be seen in FIGS. 1, 2, 3, 4, 5, 7, 15, 16;
6 and 6.1 represent the clasp system as seen in FIGS. 1, 2, 3, 4, 5, 7,14, 16.

The second drawing of FIG. 16 shows the second step in putting the device together. This Figure represents the Transporter mechanism as expanded whose length is 32 inches. This mechanism snaps firmly into the inside bottom of the bottom plastic piece and fitting snuggly into the holes marked as 8 in its four corners of the bottom piece. When the lid is closed there are also holes at the bottom of the lid so that the lid fits snuggly over the Transport mechanism. The Transport mechanism allows for the device to either be wheeled or hand carried as desired. It expands to the height desired (up to 32 total inches) and clicks into place. This piece has two parts. The bottom part, 3.1 is hollow and a little larger 3/16ths of an inch in diameter, so the the second upper rod (3), which is only 2/16ths of an inch in diameter, can expand easily.

This bottom hollow rod, 3.1 has small holes marked as 3.4 that will receive the nubs 3.3 found in the upper rod 3, and can be seen in FIGS. 1, 3, 6, 8, 9, 10, 16.

When the nubs are retracted because they have been depressed by the side handle's buttons 3.5, this will allow the top rod to move to the selected height and then snap into those same holes 3.4, on the top of 3.1 place securely; this part also has two wheels (5) attached to it for the Transporters mobility. These can be seen in FIGS. 1, 2, 3, 4, 5, 6, 7, 8, 9, 10, 11, 16. This Transport mechanism is glued flat into the inside plastic piece marked as 2.2 (FIGS. 1 and 7)

The third drawing of FIG. 16 is the foam flotation board marked as 7 (FIGS. 1, 4, 12, 16). This foam piece is placed and glued over the top of the Transport mechanism and fits snuggly into the inside of the bottom case which is 1.5 inches in depth.

7.2 represents the top view of the hole in the foam where the portable oxygen tank B lies in the middle of the foam; it is 2.5 inch wide by 11.5 inch long inverted hole/curve at 108 degree angle that is 0.5 inches deep, perpendicular at its length edges. This element can be seen in FIGS. 1, 4, 12, 16.
7.1 represents the back of the foam board and 7.3 marks the small tubular parallel indented cuts on the bottom of the foam which allows the foam to fit snuggly on top of the Transport mechanism that is glued to the inside bottom of the Plastic Device. These elements can be seen in FIGS. 1, 13, 16.

The fourth and final drawing on FIG. 16 represents the complete device put together with its lid closed and handle expanded.

FIG. 26 best represents how Prototype B is put together. The first drawing is the top lid. The second drawing is the bottom receptacle. The third drawing is the foam piece, which fits snuggly into the previous pictured bottom plastic piece. The fourth drawing shows the Transporter mechanism attached to the back of the bottom plastic piece to complete the device as the first drawing. The top plastic lid is placed over the top of the portable oxygen tank B, and snaps into place connecting with the bottom plastic piece.

### The Process of Using this Device

Open the lid of the device (1) and best viewed in FIG. 4 for Prototype A; (for Prototype B the lid is pulled from its bottom carrier plastic piece (2) as best viewed in FIG. 26. Place the portable oxygen tank, size B, into the groove 7.2 where it fits snuggly in the foam board. See FIGS. 1, 4, 12, 16, for Prototype A and FIG. 25, 26, for Prototype B. Close the lid (1) which clips into the clasp for Prototype A or for Prototype B is placed over the top of the tank and seals onto the bottom lip of (2). For both prototypes the lid fits snuggly over the top of the portable oxygen B tank and over the nipple at the top of the B tank.

The Transport mechanism for both Prototypes can be either unexpanded and the top marked as 3 can be used to carry the device or it may expanded and the device can be wheeled anywhere you want to go including from your apartment to the pool. In Prototype A, simply slide the handle to its unexpanded position and you are ready to use this device for floating your portable oxygen tank B in the pool. When you are done using it in the pool, you can either carry it back in the unexpanded position, or you can expand the Transport mechanism and wheel it back to where you need to go.

Prototype B can be used in the same manner as Prototype A, the only difference being you can remove the Transport mechanism any time you like. Both Prototypes are designed to be used as secure flotation devices for moving freely in a pool without any pull on the cannula. This device provides the legal accommodation that allows you to use the pool like everyone else.

### What it is not

It is not meant to be used like a kickboard and it is not a toy. It is not intended for swimming or a life saving device. It is not for use in large bodies of water, or water deeper than your chest. The Transporter mechanism is only meant to be used in conjunction with this device and is not to be used as a toy.

The invention claimed is:

1. A flotation transport device that buoyantly supports a portable oxygen B tank in water and can be used in transporting the portable oxygen tank on the ground to get to the water comprising:
a plastic carrying case that closes snuggly over the tank;
a closed cell foam board glued to the bottom plastic piece that provides a cradle for the portable tank to snuggly fit;
a Transport mechanism which can fit either inside the bottom plastic carrier or on its back outside piece.

2. The plastic carrying case of claim 1, wherein the plastic case consists of two pieces top and bottom, wherein the top plastic piece is molded to fit the exact size of a portable oxygen B tank that is placed in the middle of the closed cell foam board and wherein the bottom plastic piece is molded to completely encase the 1.5 inch closed cell foam piece and has the Transport mechanism either on the inside or backside.

3. The closed cell foam board of claim 1, wherein the foam board consists of closed cell foam and has a 0.5 inch deep, by 2.5 inch width, by 11.5 inch length curved surface that provides a snug cradle for the portable oxygen B tank; and provides two cylindrical parallel grooves on its backside that fit over the Transport mechanism in Prototype A, and has no grooves on its backside for Prototype B.

4. The Transport mechanism of claim 1, wherein the mechanism consists of two metal or plastic small hollow rods both rectangular in shape with one side missing; the first base rod being slightly wider in diameter has two wheels at its base, so the second rod can slide up and down to provide an expanded handle for transport.
